(19) United States
(12) Patent Application Publication
(10) Pub. No.: US 2011/0206908 A1
(43) Pub. Date: Aug. 25, 2011

(54) USE OF A PLASTIC FILM IN COLOUR LASER PRINTING

(75) Inventors: Georgios Tziovaras, Wuppertal (DE); Mehmet-Cengiz Yesildag, Leverkusen (DE); Roland Kuenzel, Leverkusen (DE); Dirk Pophusen, Bergisch Gladbach (DE); Heinz Pudleiner, Krefeld (DE); Manfred Lindner, Pracht (DE)

(73) Assignee: Bayer Material Science AG, Leverkusen (DE)

(21) Appl. No.: 13/120,847

(22) PCT Filed: Sep. 10, 2009
(86) PCT No.: PCT/EP2009/006561

§ 371 Date: May 6, 2011

(30) Foreign Application Priority Data
Sep. 24, 2008 (EP) 08016744.8

(51) Int. Cl. B32B 3/10; B41J 2/47; B32B 27/28; B32B 38/14; B05D 1/02; B29C 51/00; B42D 15/00; C08K 5/42

(52) U.S. Cl. 428/195.1; 347/225; 428/412; 156/277; 427/427.6; 264/134; 283/72; 524/167

(57) ABSTRACT

The present invention relates to the use of a plastic film as a printable medium in colour laser printing, to special plastic films for use in colour laser printing, and to their application in the production of security documents or valuable documents and plastic mouldings.

The present invention relates to the use of a plastic film as a printable medium in colour laser printing, to special plastic films for use in colour laser printing, and to their application in the production of security documents or valuable documents and plastic mouldings.

Colour-printed plastic films have been used for many years in different sectors of industry, e.g. packaging, advertising, signalling technology, motor vehicle industry, etc. However, the majority of these films are printed by analogous printing techniques such as offset printing, intaglio printing or screen printing. Depending on the plastic film used, the films have to be appropriately pretreated for analogous printing processes. Thus, for example, in the case of polyolefin films, the surface energy of the film has to be increased, for instance by flaming or plasma treatment, prior to printing. Moreover, in the analogous printing processes, the ink is applied relatively thickly, so solvents or similar ingredients cannot be completely removed from the ink layer and may remain in the ink, thereby partially dissolving or swelling the surface of the film.

Digital printing on plastic films has also developed in the last decade. The ink is applied much more thinly in digital printing than in the analogous processes. At present the digital printing of plastic films is conventionally carried out by the inkjet process. Inkjet inks can allow the use of similar ink binding techniques to the analogous printing techniques, so solvents, for example, are likewise added to these inks. This again presents the problem of partial dissolution and swelling of the surface of the plastic film. UV-curing inkjet inks have also been developed; these are cured with UV light immediately after printing. These inks have a good adhesion to plastic films, but are brittle. Other inkjet systems first print a primer or catalyst on to the film before the ink, the inks then reacting with the primer or the catalyst on the films to produce a solid layer. However, these pretreatments before the actual printing demand at least one additional step.

Another known digital printing process for plastic films is transfer printing. In this printing process the inks are on inking ribbons and are transferred to the substrate by means of pressure and heat. However, transfer printing on films is not suitable for films that are subsequently laminated by means of pressure and heat, because the ink layer would then run.

Colour laser printing is superior to the aforementioned digital printing processes particularly in the following respects: It combines a very good printing quality with a high printing rate. The printouts are more resistant to solar radiation, which can only be achieved with inkjet printers by using special inks. Laser printing costs are substantially lower and the life expectancy of the equipment is markedly longer than that of e.g. inkjet printers. Also, laser printers can survive longer idle periods without needing a service, because the nozzles cannot dry out as they do in e.g. inkjet printers. Furthermore, toners for laser printers have an appreciably longer shelf life.

Accordingly, there was a need for a colour laser printing process for plastic films as printable media which does not exhibit the aforementioned disadvantages. In particular, there was a need for plastic films suitable for this purpose which are easy to produce and which can be printed by means of colour laser printing without an additional pretreatment.

The object of the present invention was thus to find plastic films for use in such a colour laser printing process which no longer require an additional pretreatment prior to printing.

Surprisingly, it has been found that plastic films made of a thermoplastic with a surface resistivity of 10⁵ to 10¹⁴ Ω are suitable for use as a printable medium in colour laser printing.

The present invention therefore provides the use of a plastic film made of a thermoplastic with a surface resistivity of 10⁵ to 10¹⁴ Ω as a printable medium in colour laser printing.

In principle, the colour laser printing process generally operates as follows: Firstly, an imaging drum or endless belt coated with photoconductor is electrostatically negatively charged either by means of a charging corona or by means of charge rolls. The charge on the photoconductor is then neutralized by exposure to light at the places where subsequently no toner is to be applied to the drum. For the exposure to light, a laser beam is directed on to the drum line-by-line via a rotating mirror (laser scanner) while being switched on and off in a grid-like manner. As soon as the photoconductor is then brought, in the developer unit, into the immediate vicinity of the toner of opposite electrostatic charge to the photoconductor, the toner flashes across to the drum, because of its opposite charge, and adheres to it. The photoconductor then brings the toner into contact either directly with the printable medium or initially with a transfer roll or a transfer belt. The toner is then caused to flash across to the printable medium by the fact that a strong electrical charge opposite to the charge on the toner is applied to the back of the printable medium by means of a transfer roll. The printable medium reaches the fixing unit, which has essentially two hollow rolls carrying a special coating (e.g. Teflon or silicone rubber). Inside at least one of the two rolls there is a heat rod which heats the roll (e.g. up to approx. 180° C. or more) to the point where, as the printable medium passes through, the toner melts and adheres to the medium. The special coating on the rolls, and optionally a corresponding weak electrostatic charge on the rolls that repel the toner (upper roll) or attract it (lower roll, on the other side of the printable medium), ensure that as little toner as possible remains stuck to the hot rolls.

In view of this principle, it is all the more surprising that plastic films with a surface resistivity of 10⁵ to 10¹⁴ Ω are suitable for use as a printable medium in colour laser printing, because if the surface resistivity and hence the electrostatic charge on the printable medium are too low, a selective flashover of the toner ought no longer to be possible. Furthermore, if the surface resistivity and hence the electrostatic charge on the printable medium are too high, the printed image obtained is defective.

Preferred plastic films suitable for the use according to the invention have a surface resistivity of 10⁷ to 10¹³ Ω, preferably of 10⁸ to 10¹² Ω.

The surface resistivity in Ω is determined according to DIN IEC 93.

The thermoplastic can preferably be at least one thermoplastic selected from polymers of ethylenically unsaturated monomers and/or polycondensation products of bifunctional reactive compounds. For specific applications it may be advantageous to use a transparent thermoplastic.

Particularly suitable thermoplastics are polycarbonates or copolycarbonates based on diphenols, poly- or copolyacrylates and poly- or copolymethacrylates, e.g. preferably polymethyl methacrylate, polymers or copolymers with styrene, e.g. preferably transparent polystyrene or polystyrene-acrylonitrile (SAN), transparent thermoplastic polyurethanes, polyolefins, e.g. preferably transparent polypropylene grades or polyolefins based on cyclic olefins (e.g. TOPAS®, Hoechst), poly- or copolycondensation products of terephthalic acid, e.g. preferably poly- or copolyethylene terephthalate (PET or CoPET), glycol-modified PET (PETG) or poly- or copolybutylene terephthalate (PBT or CoPBT), or mixtures of the above.

Very particular preference is afforded to polycarbonates or copolycarbonates, especially those with average molecular weights M_{W} of 500 to 100,000, preferably of 10,000 to 80,000 and particularly preferably of 15,000 to 40,000, or blends thereof with at least one poly- or copolycondensation product of terephthalic acid with average molecular weights M_{W} of 10,000 to 200,000, preferably of 26,000 to 120,000. In particularly preferred embodiments of the invention, the blend is a blend of polycarbonate or copolycarbonate with poly- or copolybutylene terephthalate. Such a blend of polycarbonate or copolycarbonate with poly- or copolybutylene terephthalate can preferably contain 1 to 90 wt. % of polycarbonate or copoly-carbonate and 99 to 10 wt. % of poly- or copolybutylene terephthalate, preferably 1 to 90 wt. % of polycarbonate and 99 to 10 wt. % of polybutylene terephthalate, the proportions adding up to 100 wt. %. Particularly preferably, such a blend of polycarbonate or copolycarbonate with poly- or copolybutylene terephthalate can contain 20 to 85 wt. % of polycarbonate or copolycarbonate and 80 to 15 wt. % of poly- or copolybutylene terephthalate, preferably 20 to 85 wt. % of polycarbonate and 80 to 15 wt. % of polybutylene terephthalate, the proportions adding up to 100 wt. %. Very particularly preferably, such a blend of polycarbonate or copolycarbonate with poly- or copolybutylene terephthalate can contain 35 to 80 wt. % of polycarbonate or copolycarbonate and 65 to 20 wt. % of poly- or copolybutylene terephthalate, preferably 35 to 80 wt. % of polycarbonate and 65 to 20 wt. % of polybutylene terephthalate, the proportions adding up to 100 wt. %.

Such a particularly preferred plastic film in which the thermoplastic is a blend of at least one polycarbonate or copolycarbonate and at least one poly- or copoly-condensation product of terephthalic acid has not yet been described in the state of the art and is therefore also a subject of the present invention. The Vicat softening point B/50_{(blend)} of the thermoplastic of such a particularly preferred plastic film is below the Vicat softening point B/50_{(polycarbonate)} of the unblended poly- or copolycarbonate, and the film exhibits a particularly good printability. This particularly good printability of such a film in which the thermoplastic has a reduced Vicat softening point B/50 is all the more surprising considering that the thermal stress on the printing media due to the high fixing temperatures requires a particularly high thermal stressability and heat stability for the use of plastic films in colour laser printing, so it ought to be advantageous for the Vicat softening points B/50 to be higher rather than lower.

The Vicat softening point B/50 of a thermoplastic is measured according to ISO 306 (50 N; 50° C./h).

Particularly suitable polycarbonates or copolycarbonates in preferred embodiments are aromatic polycarbonates or copolycarbonates.

In known manner, the polycarbonates or copolycarbonates can be linear or branched.

These polycarbonates can be prepared in known manner from diphenols, carbonic acid derivatives, optionally chain terminators and optionally branching agents. Details of the preparation of polycarbonates have been disclosed in many patents for about 40 years. The following references are cited here only as examples: Schnell, “Chemistry and Physics of Polycarbonates”, Polymer Reviews, Volume 9, Interscience Publishers, New York, London, Sydney 1964; D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718; and finally Dres. U. Grigo, K. Kirchner and P. R. Müller, “Polycarbonate” in Becker/Braun, Kunststoff-Handbuch, Volume 3/1, Polycarbonate, Polyacetale, Polyester, Celluloseester, Carl Hanser Verlag, Munich, Vienna 1992, pages 117-299.

Suitable diphenols can be e.g. dihydroxyaryl compounds of general formula (I):

HO—Z—OH (I)

in which Z is an aromatic radical having 6 to 34 C atoms which can contain one or more optionally substituted aromatic rings and aliphatic or cycloaliphatic radicals/alkylaryls or heteroatoms as bridging links.

Examples of suitable dihydroxyaryl compounds are dihydroxybenzenes, dihydroxy-biphenyls, bis(hydroxyphenyl)alkanes, bis(hydroxyphenyl)cycloalkanes, bis-(hydroxyphenyl)aryls, bis(hydroxyphenyl) ethers, bis(hydroxyphenyl) ketones, bis-(hydroxyphenyl) sulfides, bis(hydroxyphenyl) sulfones, bis(hydroxyphenyl) sulfoxides, 1,1′-bis(hydroxyphenyl)diisopropylbenzenes and their ring-alkylated and ring-halogenated compounds.

These and other suitable dihydroxyaryl compounds are described e.g. in DE-A 3 832 396; FR-A 1 561 518; H. Schnell, Chemistry and Physics of Polycarbonates, Interscience Publishers, New York 1964, p. 28 et seq., p. 102 et seq.; and D. G. Legrand, J. T. Bendler, Handbook of Polycarbonate Science and Technology, Marcel Dekker, New York 2000, p. 72 et seq.

Examples of preferred dihydroxyaryl compounds are resorcinol, 4.4′-dihydroxy-biphenyl, bis(4-hydroxyphenyl)methane, bis(3,5-dimethyl-4-hydroxyphenyl)-methane, bis(4-hydroxyphenyl)diphenylmethane, 1,1-bis(4-hydroxyphenyl)-1-phenylethane, 1,1 -bis(4-hydroxyphenyl)-1-(1-naphthyl)ethane, 1,1-bis(4-hydroxy-phenyl)-1-(2-naphthyl)ethane, 2,2-bis(4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)-1-phenylpropane, 2,2-bis(4-hydroxyphenyl)hexafluoropropane, 2,4-bis(4-hydroxyphenyl)-2-methylbutane, 2,4-bis(3,5-dimethyl-4-hydroxyphenyl)-2-methylbutane, 1,1-bis(4-hydroxyphenyl)cyclohexane, 1,1-bis(3,5-dimethyl-4-hydroxyphenyl)cyclohexane, 1,1-bis(4-hydroxyphenyl)-4-methylcyclohexane, 1,3-bis [2-(4-hydroxyphenyl)-2-propyl]benzene, 1,1′-bis(4-hydroxyphenyl)-3-diiso-propylbenzene, 1,1′-bis(4-hydroxyphenyl)-4-diisopropylbenzene, 1,3-bis [2-(3,5-dimethyl-4-hydroxyphenyl)-2-propyl]benzene, bis(4-hydroxyphenyl) ether, bis(4-hydroxyphenyl) sulfide, bis(4-hydroxyphenyl) sulfone, bis(3,5-dimethyl-4-hydroxy-phenyl) sulfone and 2,2′,3,3′-tetrahydro-3,3,3′,′3-tetramethyl-1,1′-spirobi[1H-indene]-5,5′-diol, or

dihydroxydiphenylcycloalkanes of formula (Ia):

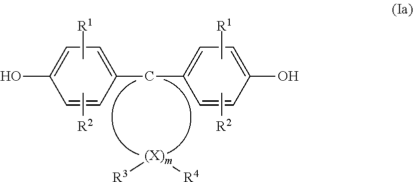

in which
R¹ and R² independently of one another are hydrogen, halogen, preferably chlorine or bromine, C₁-C₈-alkyl, C₅-C₆-cycloalkyl, C₆-C₁₀-aryl, preferably phenyl, or C₇-C₁₂-aralkyl, preferably phenyl-C₁-C₄-alkyl and especially benzyl,
m is an integer from 4 to 7, preferably 4 or 5,
R³ and R⁴ can be individually selected for each X and independently of one another are hydrogen or C₁-C₆-alkyl, and
X is carbon,
with the proviso that R³ and R⁴ are simultaneously alkyl on at least one atom X. Preferably, R³ and R⁴ in formula (Ia) are simultaneously alkyl on one or two atoms X, especially on only one atom X.

The preferred alkyl radical for the radicals R³ and R⁴ in formula (Ia) is methyl. The atoms X in the alpha position to the diphenyl-substituted C atom (C-1) are preferably not dialkyl-substituted; in the beta position to C-1, on the other hand, dialkyl substitution is preferred.

Particularly preferred dihydroxydiphenylcycloalkanes of formula (Ia) are those having 5 or 6 ring C atoms X in the cycloaliphatic radical (m=4 or 5 in formula (Ia)), e.g. the diphenols of formulae (Ia-1) to (Ia-3):

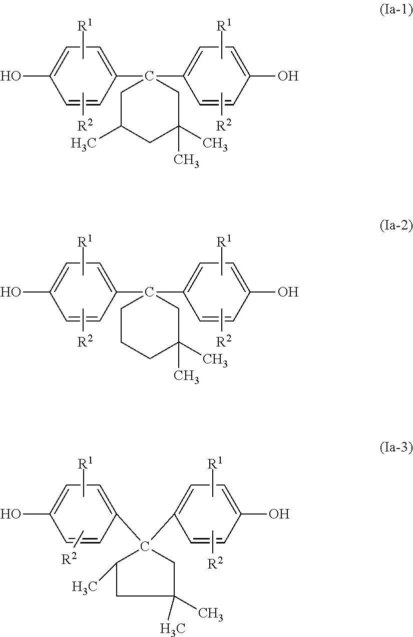

One very particularly preferred dihydroxydiphenylcycloalkane of formula (Ia) is 1,1-bis(4-hydroxyphenyl) -3,3,5-trimethylcyclohexane (formula (Ia-1) in which R¹ and R² are H).

Such polycarbonates can be prepared according to EP-A 359 953 from dihydroxy-diphenylcycloalkanes of formula (Ia).

Particularly preferred dihydroxyaryl compounds are resorcinol, 4.4′-dihydroxy-biphenyl, bis(4-hydroxyphenyl)diphenylmethane, 1,1-bis(4-hydroxyphenyl)-1-phenylethane, bis(4-hydroxyphenyl)-1-(1-naphthyl)ethane, bis(4-hydroxyphenyl)-1-(2-naphthyl)ethane, 2,2-bis(4-hydroxyphenyl)propane, 2,2-bis(3,5-dimethyl-4-hydroxyphenyl)propane, 1,1-bis(4-hydroxyphenyl)cyclohexane, 1,1-bis(3,5-dimethyl-4-hydroxyphenyl)cyclohexane, 1,1-bis(4-hydroxyphenyl)-3,3,5-trimethyl-cyclohexane, 1,1′-bis(4-hydroxyphenyl)-3-diisopropylbenzene and 1,1′-bis(4-hydroxyphenyl)-4-diisopropylbenzene.

Very particularly preferred dihydroxyaryl compounds are 4.4′-dihydroxybiphenyl, 2,2-bis(4-hydroxyphenyl)propane and 1,1-bis(4-hydroxyphenyl)-3,3,5-trimethyl-cyclohexane.

It is possible to use either one dihydroxyaryl compound to form homopoly-carbonates, or different dihydroxyaryl compounds to form copolycarbonates. It is possible to use either one dihydroxyaryl compound of formula (I) or (Ia) to form homopolycarbonates, or several dihydroxyaryl compounds of formula (I) and/or (Ia) to form copolycarbonates, in which case the different dihydroxyaryl compounds can be linked together either randomly or in blocks. In the case of copolycarbonates made up of dihydroxyaryl compounds of formulae (I) and (Ia), the molar ratio of dihydroxyaryl compounds of formula (Ia) to the other dihydroxyaryl compounds of formula (I) that may be used concomitantly is preferably between 99 mol % of (Ia) to 1 mol % of (I) and 2 mol % of (Ia) to 98 mol % of (I), particularly preferably between 99 mol % of (Ia) to 1 mol % of (I) and 10 mol % of (Ia) to 90 mol % of (I) and especially between 99 mol % of (Ia) to 1 mol % of (I) and 30 mol % of (Ia) to 70 mol % of (I).

One very particularly preferred copolycarbonate can be prepared using 1,1-bis(4-hydroxyphenyl)-3,3,5-trimethylcyclohexane and 2,2-bis(4-hydroxyphenyl)propane as dihydroxyaryl compounds of formulae (Ia) and (I).

Suitable carbonic acid derivatives can be e.g. diaryl carbonates of general formula (II):

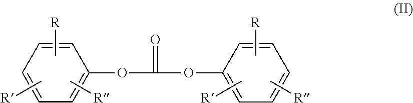

in which
R, R′ and R″ are identical or different and independently of one another are hydrogen, linear or branched C₁-C₃₄-alkyl, C₇-C₃₄-alkylaryl or C₆-C₃₄-aryl, it also being possible for R to be —COO—R′″, in which R′″ is hydrogen, linear or branched C₁-C₃₄-alkyl, C₇-C₃₄-alkylaryl or C₆-C₃₄-aryl.

Examples of preferred diaryl carbonates are diphenyl carbonate, methylphenyl phenyl carbonates and di(methylphenyl) carbonates, 4-ethylphenyl phenyl carbonate, di(4-ethylphenyl) carbonate, 4-n-propylphenyl phenyl carbonate, di(4-n-propylphenyl) carbonate, 4-isopropylphenyl phenyl carbonate, di(4-isopropylphenyl) carbonate, 4-n-butylphenyl phenyl carbonate, di(4-n-butylphenyl) carbonate, 4-isobutylphenyl phenyl carbonate, di(4-isobutylphenyl) carbonate, 4-tert-butylphenyl phenyl carbonate, di(4-tert-butylphenyl) carbonate, 4-n-pentylphenyl phenyl carbonate, di(4-n-pentylphenyl) carbonate, 4-n-hexylphenyl phenyl carbonate, di(4-n-hexylphenyl) carbonate, 4-isooctylphenyl phenyl carbonate, di(4-isooctylphenyl) carbonate, 4-n-nonylphenyl phenyl carbonate, di(4-n-nonylphenyl) carbonate, 4-cyclohexylphenyl phenyl carbonate, di(4-cyclohexylphenyl) carbonate, 4-(1-methyl-1-phenylethyl)phenyl phenyl carbonate, di[4-(1-methyl-1-phenylethyl)phenyl] carbonate, biphenyl-4-yl phenyl carbonate, di(biphenyl-4-yl) carbonate, 4-(1-naphthyl)phenyl phenyl carbonate, 4-(2-naphthyl)phenyl phenyl carbonate, di[4-(1-naphthyl)phenyl] carbonate, di[4-(2-naphthyl)phenyl] carbonate, 4-phenoxyphenyl phenyl carbonate, di(4-phenoxyphenyl) carbonate, 3-pentadecylphenyl phenyl carbonate, di(3-pentadecylphenyl) carbonate, 4-tritylphenyl phenyl carbonate, di(4-tritylphenyl) carbonate, (methyl salicylate) phenyl carbonate, di(methyl salicylate) carbonate, (ethyl salicylate) phenyl carbonate, di(ethyl salicylate) carbonate, (n-propyl salicylate) phenyl carbonate, di(n-propyl salicylate) carbonate, (isopropyl salicylate) phenyl carbonate, di(isopropyl salicylate) carbonate, (n-butyl salicylate) phenyl carbonate, di(n-butyl salicylate) carbonate, (isobutyl salicylate) phenyl carbonate, di(isobutyl salicylate) carbonate, (tert-butyl salicylate) phenyl carbonate, di(tert-butyl salicylate) carbonate, di(phenyl salicylate) carbonate and di(benzyl salicylate) carbonate.

Particularly preferred diaryl compounds are diphenyl carbonate, 4-tert-butylphenyl phenyl carbonate, di(4-tert-butylphenyl) carbonate, biphenyl-4-yl phenyl carbonate, di(biphenyl-4-yl) carbonate, 4-(1-methyl-1-phenylethyl)phenyl phenyl carbonate, di[4-(1-methyl-1-phenylethyl)phenyl] carbonate and di(methyl salicylate) carbonate.

Diphenyl carbonate is very particularly preferred.

It is possible to use either one diaryl carbonate or different diaryl carbonates.

To control/modify the end groups, it is additionally possible e.g. to use as chain terminators one or more monohydroxyaryl compounds which were not used to prepare the diaryl carbonate(s). Said monohydroxyaryl compounds can be those of general formula (III):

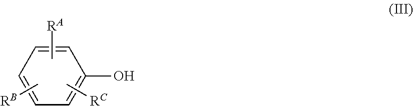

in which
R^{A} is linear or branched C₁-C₃₄-alkyl, C₇-C₃₄-alkylaryl, C₆-C₃₄-aryl or —COO—R^{D}, in which R^{D} is hydrogen, linear or branched C₁-C₃₄-alkyl, C₇-C₃₄-alkylaryl or C₆-C₃₄-aryl, and
R^{B}, R^{C} are identical or different and independently of one another are hydrogen, linear or branched C₁-C₃₄-alkyl, C₇-C₃₄-alkylaryl or C₆-C₃₄-aryl.

Examples of such monohydroxyaryl compounds are 1-, 2- or 3 -methylphenol, 2,4-dimethylphenol, 4-ethylphenol, 4-n-propylphenol, 4-isopropylphenol, 4-n-butyl-phenol, 4-isobutylphenol, 4-tert-butylphenol, 4-n-pentylphenol, 4-n-hexylphenol, 4-isooctylphenol, 4-n-nonylphenol, 3-pentadecylphenol, 4-cyclohexylphenol, 4-(1-methyl-1-phenylethyl)phenol, 4-phenylphenol, 4-phenoxyphenol, 4-(1-naphthyl)-phenol, 4-(2-naphthyl)phenol, 4-tritylphenol, methyl salicylate, ethyl salicylate, n-propyl salicylate, isopropyl salicylate, n-butyl salicylate, isobutyl salicylate, tert-butyl salicylate, phenyl salicylate and benzyl salicylate.

4-Tert-butylphenol, 4-isooctylphenol and 3-pentadecylphenol are preferred.

Suitable branching agents can be compounds having three or more functional groups, preferably three or more hydroxyl groups.

Examples of suitable compounds having three or more phenolic hydroxyl groups are phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol and tetra(4-hydroxyphenyl)methane.

Examples of other suitable compounds having three or more functional groups are 2,4-dihydroxybenzoic acid, trimesic acid trichloride, cyanuric acid trichloride and 3,3-bis(3-methyl-4-hydroxyphenyl)-2-oxo-2,3-dihydroindole.

Preferred branching agents are 3,3-bis(3-methyl-4-hydroxyphenyl)-2-oxo-2,3-dihydroindole and 1,1,1-tri(4-hydroxyphenyl)ethane.

In preferred embodiments of the invention, suitable poly- or copolycondensation products of terephthalic acid are polyalkylene terephthalates. Examples of suitable polyalkylene terephthalates are reaction products of aromatic dicarboxylic acids or reactive derivatives thereof (e.g. dimethyl esters or anhydrides) and aliphatic, cycloaliphatic or araliphatic diols, and mixtures of these reaction products.

Preferred polyalkylene terephthalates can be prepared by known methods from terephthalic acid (or reactive derivatives thereof) and aliphatic or cycloaliphatic diols having 2 to 10 C atoms (Kunststoff-Handbuch, Vol. VIII, p. 695 et seq., Karl-Hanser-Verlag, Munich 1973).

Preferred polyalkylene terephthalates contain at least 80 mol %, preferably 90 mol %, of terephthalic acid residues, based on the dicarboxylic acid component, and at least 80 mol %, preferably at least 90 mol %, of ethylene glycol and/or butane-1,4-diol residues, based on the diol component.

In addition to terephthalic acid residues, the preferred polyalkylene terephthalates can contain up to 20 mol % of residues of other aromatic dicarboxylic acids having 8 to 14 C atoms, or of aliphatic dicarboxylic acids having 4 to 12 C atoms, such as residues of phthalic acid, isophthalic acid, naphthalene-2,6-dicarboxylic acid, 4,4′-biphenyldicarboxylic acid, succinic acid, adipic acid, sebacic acid, azelaic acid or cyclohexanediacetic acid.

In addition to ethylene glycol/butane-1,4-diol residues, the preferred polyalkylene terephthalates can contain up to 20 mol % of other aliphatic diols having 3 to 12 C atoms, or of cycloaliphatic diols having 6 to 21 C atoms, e.g. residues of propane-1,3-diol, 2-ethylpropane-1,3-diol, neopentyl glycol, pentane-1,5-diol, hexane-1,6-diol, cyclohexane-1,4-dimethanol, 3-methylpentane-2,4-diol, 2-methylpentane-2,4-diol, 2,2,4-trimethylpentane-1,3-diol, 2-ethylhexane-1,6-diol, 2,2-diethylpropane-1,3-diol, hexane-2,5-diol, 1,4-di(beta-hydroxyethoxy)benzene, 2,2-bis(4-hydroxy-cyclohexyl)propane, 2,4-dihydroxy-1,1,3,3-tetramethylcyclobutane, 2,2-bis(3 -beta-hydroxyethoxyphenyl)propane and 2,2-bis(4-hydroxypropoxyphenyl)propane (cf. DE-OS 24 07 674, 24 07 776, 27 15 932).

The polyalkylene terephthalates can be branched by the incorporation of relatively small amounts of tri- or tetrahydric alcohols or tri- or tetrabasic carboxylic acids, as described e.g. in DE-OS 19 00 270 and U.S. Pat. No. 3 692 744. Examples of preferred branching agents are trimesic acid, trimellitic acid, trimethylolethane and -propane and pentaerythritol.

It is preferable to use not more than 1 mol % of branching agent, based on the acid component.

Particular preference is afforded to polyalkylene terephthalates which have been prepared only from terephthalic acid and reactive derivatives thereof (e.g. its dialkyl esters) and ethylene glycol and/or butane-1,4-diol, and mixtures of these poly-alkylene terephthalates.

Other preferred polyalkylene terephthalates are copolyesters prepared from at least two of the aforementioned acid components and/or at least two of the aforementioned alcohol components, particularly preferred copolyesters being poly-(ethylene glycol/butane-1,4-diol) terephthalates.

The polyalkylene terephthalates preferably used as a component have an intrinsic viscosity preferably of approx. 0.4 to 1.5 dl/g, particularly preferably of 0.5 to 1.3 dl/g, measured in each case in phenol/o-dichlorobenzene (1:1 parts by weight) at 25° C.

One particularly suitable plastic film for the use according to the invention has a layer structure comprising at least three layers, including
(1) at least one inner layer made of a thermoplastic with a Vicat softening point B/50₍ᵢₙₙₑᵣ₎, and
(2) at least one lower and at least one upper layer (outer layers) made of a thermoplastic with a Vicat softening point B/50₍ₒᵤₜₑᵣ₎ that is below the Vicat softening point B/50₍ᵢₙₙₑᵣ₎,
   at least the lower or upper layer, preferably the lower and upper layers, having a surface resistivity of 10⁵ to 10¹⁴ Ω.

One very particularly suitable plastic film for the use according to the invention, having such a layer structure, comprises three layers, including one inner layer, one lower layer and one upper layer, made, independently of one another, of the aforementioned thermoplastics.

Such a plastic film having the above-described layer structures has not yet been described in the state of the art and is therefore also a subject of the present invention. Such a plastic film has a surprisingly good printability and, by virtue of the middle layer made of a thermoplastic with a higher Vicat softening point B/50₍ᵢₙₙₑᵣ₎, also has an improved thermal stressability.

In these preferred layer structures of the plastic film, the Vicat softening point B/50₍ₒᵤₜₑᵣ₎ is preferably at least 5° C., particularly preferably at least 10° C., below the Vicat softening point B/50₍ᵢₙₙₑᵣ₎.

Suitable thermoplastics for these preferred layer structures are those already described above. In preferred embodiments of such a plastic film, the thermoplastic of the lower and upper layers can be a blend of at least one polycarbonate or copolycarbonate and at least one poly- or copolycondensation product of terephthalic acid, very particularly preferably a blend of polycarbonate or copolycarbonate with poly- or copolybutylene terephthalate.

In preferred embodiments of the present invention, in order to achieve the surface resistivity, the thermoplastic of the plastic films used according to the invention can contain e.g. an additive selected from tertiary or quaternary, preferably quaternary, ammonium or phosphonium salts of a partially fluorinated or perfluorinated organic acid, or from quaternary ammonium or phosphonium hexafluorophosphates, preferably of a partially fluorinated or perfluorinated alkylsulfonic acid, particularly preferably of a perfluoroalkylsulfonic acid.

Such additives and their use as antistatics are described in the literature (cf. DE-A 25 06 726, EP-A 1 290 106, EP 897 950 A2 or U.S. Pat. No. 6,372,829).

Examples of possible anions of such salts that are suitable according to the invention as additives are preferably partially fluorinated or perfluorinated alkylsulfonates, cyanoperfluoroalkylsulfonamides, bis(cyano)perfluoroalkylsulfonyl methides, bis-(perfluoroalkylsulfonyl)imides, bis(perfluoroalkylsulfonyl) methides, tris(perfluoro-alkylsulfonyl) methides or hexafluorophosphates. Partially fluorinated or per-fluorinated alkylsulfonates are particularly preferred and perfluoroalkylsulfonates are very particularly preferred. Examples of possible cations of such salts that are suitable according to the invention as additives are preferably acyclic or cyclic, tertiary or quaternary ammonium or phosphonium cations. Examples of suitable cyclic cations are pyridinium, pyridazinium, pyrimidinium, pyrazinium, imidazolium, pyrazolium, oxazolium or thiazolium cations. Examples of suitable acyclic cations are those forming part of formula (IV) below.

Examples of quaternary ammonium or phosphonium salts of a perfluoroalkyl-sulfonic acid that are particularly suitable according to the invention are those of general formula (IV):

R¹—SO₃XR²R³R⁴R⁵ (IV)

in which
X is N or P, preferably N,
R¹ are partially fluorinated or perfluorinated, cyclic or linear, branched or unbranched carbon chains having 1 to 30 carbon atoms, preferably 4 to 8 carbon atoms, preferred cyclic radicals having 5 to 7 carbon atoms,
R² are unsubstituted or halogen-, hydroxy-, cycloalkyl- or alkyl-substituted, especially C₁- to C₃-alkyl- or C₅- to C₇-cycloalkyl-substituted, cyclic or linear, branched or unbranched carbon chains having 1 to 30 carbon atoms, preferably 3 to 10 carbon atoms, preferred cyclic radicals having 5 to 7 carbon atoms, particularly preferably propyl, 1-butyl, 1-pentyl, hexyl, isopropyl, isobutyl, tert-butyl, neopentyl, 2-pentyl, isopentyl, isohexyl, cyclohexyl, cyclohexylmethyl and cyclopentyl, and
R³, R⁴, R⁵ independently of one another are each unsubstituted or halogen-, hydroxy-, cycloalkyl- or alkyl-substituted, especially C₁- to C₃-alkyl- or C₅- to C₇-cycloalkyl-substituted, cyclic or linear, branched or unbranched carbon chains having 1 to 30 carbon atoms, preferably 1 to 10 carbon atoms, preferred cyclic radicals having 5 to 7 carbon atoms, particularly preferably methyl, ethyl, propyl, 1-butyl, 1-pentyl, hexyl, 1-isopropyl, isobutyl, tert-butyl, neopentyl, 2-pentyl, isopentyl, isohexyl, cyclohexyl, cyclohexylmethyl and cyclopentyl.

A preferred selection is made from the ammonium or phosphonium salts in which

X is N or P, preferably N,
R¹ are perfluorinated linear or branched carbon chains having 1 to 30 carbon atoms, preferably 4 to 8 carbon atoms,
R² independently of one another are each halogenated or non-halogenated linear or branched carbon chains having 1 to 30 carbon atoms, preferably 3 to 10 carbon atoms, particularly preferably propyl, 1-butyl, 1-pentyl, hexyl, isopropyl, isobutyl, tert-butyl, neopentyl, 2-pentyl, isopentyl and isohexyl, and
R³, R⁴, R⁵ independently of one another are each halogenated or non-halogenated linear or branched carbon chains having 1 to 30 carbon atoms, preferably 1 to 10 carbon atoms, particularly preferably methyl, ethyl, propyl, 1-butyl, 1-pentyl, hexyl, isopropyl, isobutyl, tert-butyl, neopentyl, 2-pentyl, isopentyl and isohexyl.

The following suitable quaternary ammonium or phosphonium salts are preferred:
perfluorooctanesulfonic acid tetrapropylammonium salt,
perfluorobutanesulfonic acid tetrapropylammonium salt,
perfluorooctanesulfonic acid tetrabutylammonium salt,
perfluorobutanesulfonic acid tetrabutylammonium salt,
perfluorooctanesulfonic acid tetrapentylammonium salt,
perfluorobutanesulfonic acid tetrapentylammonium salt,
perfluorooctanesulfonic acid tetrahexylammonium salt,
perfluorobutanesulfonic acid tetrahexylammonium salt,
perfluorobutanesulfonic acid trimethylneopentylammonium salt,
perfluorooctanesulfonic acid trimethylneopentylammonium salt,
perfluorobutanesulfonic acid dimethyldineopentylammonium salt,
perfluorooctanesulfonic acid dimethyldineopentylammonium salt,
N-methyltripropylammonium perfluorobutylsulfonate,
N-ethyltripropylammonium perfluorobutylsulfonate,
tetrapropylammonium perfluorobutylsulfonate,
diisopropyldimethylammonium perfluorobutylsulfonate,
diisopropyldimethylammonium perfluorooctylsulfonate,
N-methyltributylammonium perfluorooctylsulfonate,
cyclohexyldiethylmethylammonium perfluorooctylsulfonate,
cyclohexyltrimethylammonium perfluorooctylsulfonate,
   and the corresponding phosphonium salts. The ammonium salts are preferred.

Preferably, it is also possible to use one or more of the aforementioned quaternary ammonium or phosphonium salts, i.e. mixtures thereof.

The following are very particularly suitable: perfluorooctanesulfonic acid tetra-propylammonium salt, perfluorooctanesulfonic acid tetrabutylammonium salt, perfluorooctanesulfonic acid tetrapentylammonium salt, perfluorooctanesulfonic acid tetrahexylammonium salt and perfluorooctanesulfonic acid dimethyl-diisopropylammonium salt, as well as the corresponding perfluorobutanesulfonic acid salts.

In one very particularly preferred embodiment of the invention, perfluoro-butanesulfonic acid dimethyldiisopropylammonium salt (diisopropyl-dimethylammonium perfluorobutylsulfonate) is used.

Said salts are known or can be prepared by known methods. The sulfonic acid salts can be prepared e.g. by bringing together equimolar amounts of the free sulfonic acid and the hydroxyl form of the appropriate cation in water at room temperature, and concentrating the solution. Other preparative processes are described e.g. in DE-A 1 966 931 and NL-A 7 802 830.

Said salts are added to the thermoplastics in amounts preferably of 0.001 to 2 wt. %, particularly preferably of 0.1 to 1 wt. %, prior to shaping of the plastic film, which can be effected e.g. by extrusion or coextrusion.

Other conventional additives and accessory agents known to those skilled in the art (e.g. auxiliary substances and reinforcing agents) can also be added to the thermoplastics. The plastic films to be used according to the invention can also be e.g. filled plastic films, i.e. plastic films with added fillers.

The thickness of the plastic films to be used according to the invention is preferably 55 μm to 750 μm, particularly preferably 100 μm to 300 μm. In preferred embodiments of the invention, where the plastic film has a layer structure comprising at least three layers, the ratio of the thickness of the inner layer or the total thickness of several inner layers, if appropriate, to the thickness of the lower and upper layers or the respective total thickness of several lower and upper layers, if appropriate, is 1:1:1 to 20:1:1, preferably 2:1:1 to 5:1:1.

The plastic films to be used according to the invention are preferably produced by extrusion or coextrusion of the thermoplastics (optionally containing additives). It is not necessary to carry out a further aftertreatment, e.g. of the surface, prior to using these plastic films as a printable medium in colour laser printing. The plastic films to be used according to the invention thus constitute a printable medium for colour laser printing which is easy to produce.

For example, the plastic films to be used according to the invention can be printed perfectly with a resolution of up to 600 dpi. Resolutions above 600 dpi can also be obtained with the plastic films to be used according to the invention in colour laser printing.

The invention also provides a process for the printing of a plastic film by means of colour laser printing, characterized in that one of the above-described plastic films made of a thermoplastic with a surface resistivity of 10⁵ to 10¹⁴ Ω is used as the printable medium.

By virtue of its high-quality printed image, a film printed by the aforementioned process is particularly suitable e.g. for use in the production of security documents or valuable documents, particularly preferably personalized security documents, or plastic mouldings, particularly preferably those with decorative overprinting.

The present invention therefore also provides a security document or valuable document, preferably a personalized security document, or a plastic moulding containing a plastic film printed by the process according to the invention.

Security documents or valuable documents, especially personalized security documents, e.g. ID cards, often have a layer composite structure containing a plastic film printed by the process according to the invention, said structure subsequently being laminated to give a firm composite structure. Among other things, this prevents the personalized information and security features in the document in question from being replaced and falsified.

The present invention therefore also provides a process for the production of a security document or valuable document, preferably a personalized security document, characterized in that a layer composite structure containing a plastic film printed by the process according to the invention is laminated.

Plastic mouldings can likewise have a layer composite structure containing a plastic film printed by the process according to the invention, said structure subsequently being thermally formed and optionally also sprayed on the back with another thermoplastic.

The present invention therefore also provides a process for the production of a plastic moulding, characterized in that a layer composite structure containing a plastic film printed by the process according to the invention is thermally formed and then optionally sprayed on the back with a thermoplastic.

In particular here, the film to be used according to the invention has the advantage that, even with this thermal aftertreatment by means of lamination or thermal forming and optional spraying on the back, the quality of the printed image is not impaired. Thus, in the case of security documents or valuable documents, the information content and the function of the security features are not lost and the plastic mouldings do not lose their decorative quality.

The Examples which follow serve to illustrate the invention without implying a limitation.

### EXAMPLES

The surface resistivity in Ω was determined according to DIN TEC 93. The roughness was determined according to ISO 4288.

### Example 1

A 250 μm thick polycarbonate film based on the polycarbonate Makrolon 3108® from Bayer MaterialScience AG and perfluorooctanesulfonic acid tetraethyl-ammonium salt (Bayowet 248® from Bayer MaterialScience AG) as additive, having a composition of 98.5% Makrolon 3108® and 1.5% Bayowet 248®, was produced by extrusion at a stock temperature of 280° C. The surface resistivity of the film, determined according to DIN IEC 93 (Ω), was 6.0·10¹² Ω.

A DIN A4 sample of this film was printed with an HP colour laser printer (model: HP Colour Laserjet 4500 DN). The film was printed on the side numbered 2 (roughness R3z<9 μm).

Print sample: full-cover 4-colour print

Resolution of the print sample: 600 dpi

The film could be printed impeccably and showed a perfect printed image.

### Example 2

Another DIN A4 sample of the film produced as described in Example 1 was printed with an HP colour laser printer (model: HP Colour Laserjet 4500 DN). The film was printed on the side numbered 2 (roughness R3z<9 μm).

Print sample: full-cover 4-colour print

Resolution of the print sample: 600 dpi

The film could be printed impeccably and showed a perfect printed image.

To enhance the contrast, the film was screen-printed with white ink (Noriphan HTR white 945 from Pröll) on top of the digitally printed sample. It was then formed by HPF (high pressure forming) on a Niebling SAMK 360 forming machine. The unwanted projecting parts of the film were cut away by punching so that the formed piece of film fitted precisely into the cavity of an appropriate injection mould. The formed piece of film was sprayed on the back with Bayblend® T65.

This process did not visibly impair the printed image on the finished moulding.

### Example 3

Another DIN A4 sample of the film produced as described in Example 1 was printed with an HP colour laser printer (model: HP Colour Laserjet 4500 DN). The film was printed on the side numbered 2 (roughness R3z<9 μm).

Print sample: full-cover 4-colour print

Resolution of the print sample: 600 dpi

The film could be printed impeccably and showed a perfect printed image.

The printed film was placed between two further films based on the polycarbonate Makrolon 3108® from Bayer MaterialScience AG. The stack of films was placed in a Bürkle laminating press and laminated under pressure and heat. The lamination parameters were as follows:

Temperature: 175° C.

Low preliminary pressure during heating-up period: 15 N/cm²

Heating-up time: 8 minutes

High pressure during lamination: 300 N/cm²

Lamination time: 2 minutes

The press was then cooled with the pressure still applied. The press opened when the temperature reached 38° C.

Cards were punched out of the laminated sheet with the dimensions according to ISO 7810.

There was no visible impairment at all of the printed image on the laminated card.

### Comparative Example 1

A DIN A4 sample of a polycarbonate film coated with indium tin oxide (ITO) and having a surface resistance of 2·10³ Ω (determined according to DIN IEC 93) was printed with an HP colour laser printer (model: HP Colour Laserjet 4500 DN). The film was printed on the ITO-coated side.

Print sample: full-cover 4-colour print

Resolution of the print sample: 600 dpi

The film could scarcely be printed and showed virtually no printed image.

### Comparative Example 2

A DIN A4 sample of a polycarbonate film with a surface resistance of 10¹⁶ Ω (determined according to DIN TEC 93) was printed with an HP colour laser printer (model: HP Colour Laserjet 4500 DN). The film was printed on the side numbered 2 (roughness R3z<9 μm).

Print sample: full-cover 4-colour print

Resolution of the print sample: 600 dpi

The film could be printed, but showed a defective, streaky printed image.

1. Use of a plastic film made of a thermoplastic with a surface resistivity of 10⁵ to 10¹⁴ Ω as a printable medium in colour laser printing.

2. Use according to claim 1, characterized in that the plastic film has a surface resistivity of 10⁷ to 10¹³ Ω, preferably of 10⁸ to 10¹² Ω.

3. Use according to claim 1 or 2, characterized in that the thermoplastic is at least one thermoplastic selected from polymers of ethylenically unsaturated monomers and/or polycondensation products of bifunctional reactive compounds.

4. Use according to at least one of claims 1 to 3, characterized in that the thermoplastic is one or more polycarbonates or copolycarbonates based on diphenols, poly- or copolyacrylates and poly- or copolymethacrylates, polymers or copolymers with styrene, polyurethanes, polyolefins, poly- or copolycondensation products of terephthalic acid, or mixtures of the above.

5. Use according to at least one of claims 1 to 4, characterized in that the thermoplastic is a blend of at least one polycarbonate or copolycarbonate and at least one poly- or copolycondensation product of terephthalic acid.

6. Use according to at least one of claims 1 to 5, characterized in that the plastic film has a layer structure comprising at least three layers, including
(1) at least one inner layer made of a thermoplastic with a Vicat softening point B/50₍ᵢₙₙₑᵣ₎, and
(2) at least one lower and one upper layer (outer layers) made of a thermoplastic with a Vicat softening point B/50₍ₒᵤₜₑᵣ₎ that is below the Vicat softening point B/50₍ᵢₙₙₑᵣ₎, at least the lower or upper layer having the surface resistivity stated in claim 1 or 2.

7. Use according to claim 6, characterized in that the Vicat softening point B/50₍ₒᵤₜₑᵣ₎ is at least 5° C., preferably at least 10° C., below the Vicat softening point B/50₍ᵢₙₙₑᵣ₎.

8. Use according to claim 6 or 7, characterized in that the thermoplastic of the lower and upper layers is a blend of at least one polycarbonate or copolycarbonate and at least one poly- or copolycondensation product of terephthalic acid.

9. Use according to at least one of claims 1 to 8, characterized in that, to achieve the surface resistivity, the thermoplastic contains an additive selected from quaternary ammonium or phosphonium salts of a partially fluorinated or perfluorinated organic acid, or from quaternary ammonium or phosphonium hexafluorophosphates.

10. Plastic film made of a thermoplastic with a surface resistivity of 10⁵ to 10¹⁴ Ω, characterized in that the thermoplastic is a blend of at least one polycarbonate or copolycarbonate and at least one poly- or copoly-condensation product of terephthalic acid.

11. Plastic film made of a thermoplastic with a surface resistivity of 10⁵ to 10¹⁴ Ω, characterized in that it has a layer structure comprising at least three layers, including
(1) at least one inner layer made of a thermoplastic with a Vicat
(2) at least one lower and at least one upper layer (outer layers) made of a thermoplastic with a Vicat softening point B/50₍ₒᵤₜₑᵣ₎ that is below the Vicat softening point B/50₍ᵢₙₙₑᵣ₎,
at least the lower or upper layer having the stated surface resistivity.

12. Process for the printing of a plastic film by means of colour laser printing, characterized in that a plastic film made of a thermoplastic with a surface resistivity of 10⁵ to 10¹⁴ Ω is used as the printable medium.

13. Security document or valuable document, preferably personalized security document, or plastic moulding containing a printed plastic film obtainable by the process according to claim 12.

14. Process for the production of a security document or valuable document, preferably a personalized security document, characterized in that a layer composite structure containing a printed plastic film obtainable by the process according to claim 12 is laminated.

15. Process for the production of a plastic moulding, characterized in that a layer composite structure containing a printed plastic film obtainable by the process according to claim 12 is thermally formed and then optionally sprayed on the back with a thermoplastic.
